(19) United States
(12) Patent Application Publication
(10) Pub. No.: US 2006/0176683 A1
(43) Pub. Date: Aug. 10, 2006

(54) Outdoor light

(76) Inventor: Chen-Cheng Chien, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,081

(22) Filed: Feb. 8, 2005

(51) Int. Cl. F21S 8/00

(52) U.S. Cl. 362/153

(57) ABSTRACT

An outdoor light has a top, a body and a base. The top is made of a transparent or translucent material through which light passes. The body has an illumination source mounted inside the body. The base has a power supply connected to the illumination source and comprises multiple hollow necks, multiple legs selectively mounted inside the hollow necks, and a hook mounted on the base. So, the outdoor light can stand, be hung or put on the ground when used to fill multiple illumination requirements.

### BACKGROUND OF THE INVENTION

1. Field of Invention

The present invention relates to an outdoor light, more particular to an outdoor light with multiple ways of mounting and using the light.

2. Description of the Related Art

A conventional outdoor light only has a capability to perform a single illuminating function but cannot be used in many ways. For example, when people go camping or chat outdoors in the evening or at night, numerous different types of light (i.e. spotlights, floodlights, marker lights, etc.) are required for illumination.

The outdoor light in accordance with the present invention obviates or mitigates the aforementioned problems.

### SUMMARY OF THE INVENTION

The primary objective of the present invention is to provide an outdoor light that can be used in multiple ways to meet various requirements for illumination.

An outdoor light to meet the objective of the current invention has a top, a body and a base. The top is made of a transparent or translucent material through which light passes. The body has an illumination source mounted inside the body. The base has a power supply connected to the illumination source and comprises multiple hollow necks, multiple legs and a hook. The power supply is mounted inside the base connected to the illumination source. The legs are mounted selectively inside the hollow necks. The hook is attached to the base. The legs and the hook allow the outdoor light to stand, be hung or put on the ground to fill multiple illumination requirements.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an outdoor light in accordance with the present invention;

FIG. 2 is an exploded perspective view of the outdoor light in FIG. 1;

FIG. 3 is a side view of the outdoor light in FIG. 1;

FIG. 4 is an operational side view of the outdoor light in FIG. 1 hung by a hook; and

FIG. 5 is an operational side view of the outdoor light in FIG. 1 placed on the ground.

### DETAILED DESCRIPTION OF THE INVENTION

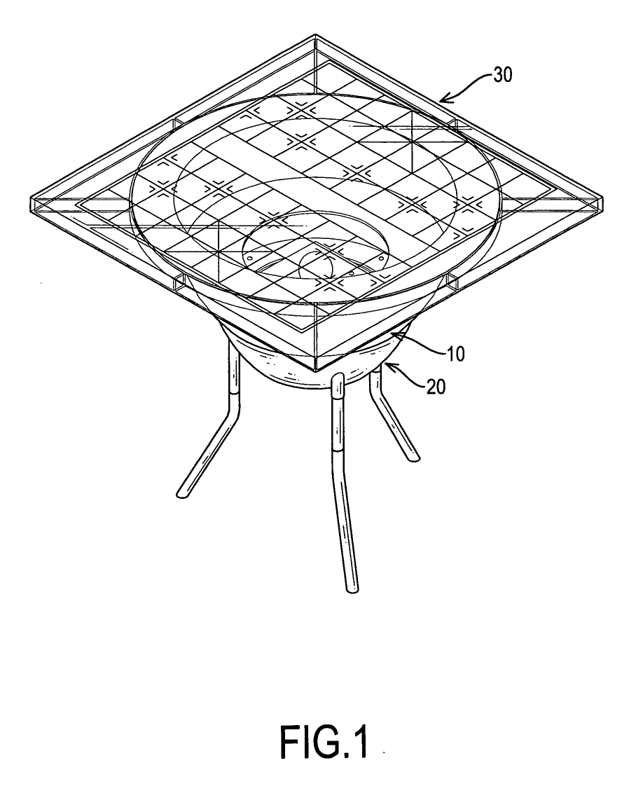

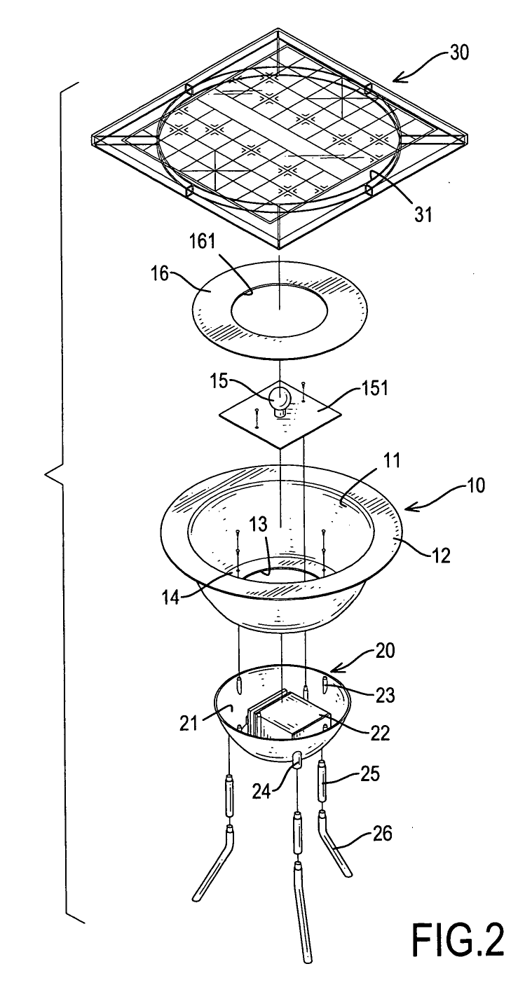

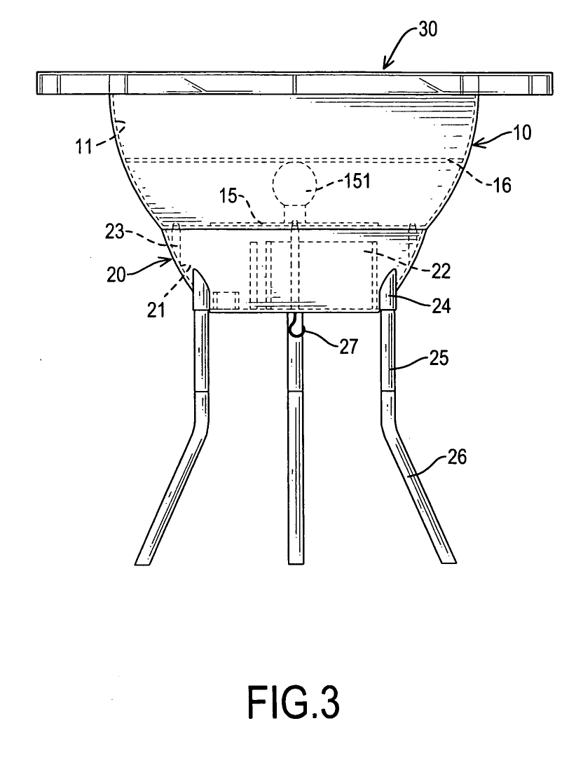

With reference to FIGS. 1 to 3, an outdoor light in accordance with the present invention has a body (10), a base (20) and a top (30).

The body (10) has a top edge, a bottom edge, a bottom, an internal cavity (11), an optional flange (12), a central hole (13), an optional lip (14), an illumination source (15) and an optional ring (16) and can be shaped as many shapes. In a preferred embodiment, the body (10) is bowl-shaped. The internal cavity (11) is defined inside the body (10). The flange (12) is formed around and extends out from the top edge of the body (10). The central hole (13) is defined in the bottom of the body (10), and the lip (14) is formed around and extends radially in from the bottom edge of the body (10). The illumination source (15) has an optional bracket (151) and is mounted on the bracket (151). In a preferred embodiment, the bracket (151) is mounted on the lip (14) of the body (10). The ring (16) is made of a translucent material, engaged inside the cavity (11) of the body (10) and has a central hole (161). Light from the illumination source (15) passes through the central hole (161). The ring (16) may be colored, so light passing through the ring (16) will have color.

The base (20) is mounted on the bottom of the body (10) and in certain embodiments, may be formed integrally with the bottom of the body (10). The base (20) has a top edge, a bottom, a cavity (21), an inner surface, an outer surface, a power supply (22), multiple optional post holders (23), multiple optional hollow necks (24), multiple optional extension rods (25), multiple optional legs (26) and an optional hook (27). The top edge of the base (20) is mounted on the bottom of the body (10). The cavity (21) is defined inside the base (20). The power supply (22) is mounted inside the cavity (21) and is connected to the illumination source (15). The post holders (23) are formed on the inner surface of the base (20). In a preferred embodiment, multiple screws are screwed through the lip (14) of the body and respectively into the post holders (23) of the base (20). The multiple hollow necks (24) are mounted on the outer surface of the base (20). The extension rods (25) correspond respectively to the receiving posts (24) and are selectively mounted respectively in the hollow necks (24). Each extension rod (25) has a proximal end and a distal end. The proximal end of each extension rod (25) is mounted in the corresponding hollow neck (24). Each leg (26) has a proximal end. The proximal ends of the legs (26) may be mounted respectively in the corresponding neck (24) or the corresponding distal ends of the extension rods (25). The hook (27) is mounted on the outer surface of the base (20) at the bottom.

The top (30) is mounted on the top of the body (10) and has a top surface, a bottom surface, an edge and an optional bottom recess (31). The bottom recess (31) is defined in the bottom surface of the top (30). The flange (12) of the body (10) is mounted in the bottom recess (31). The top (30) is made from a transparent or translucent material. In a preferred embodiment, a pattern such as a checker board can be formed on the top surface of the top (30).

When the outdoor light in accordance with the present invention is used, the illumination source (15) is turned on and emits light, and the light will pass through the transparent or translucent top (30), so people will see objects clearly in the evening or at night. Also, because the outdoor light in accordance with the present invention can be formed as a table with the legs (26), the extension rods (25) or both inserting inside the hollow necks (24), people can clearly see objects placed on the top (30).

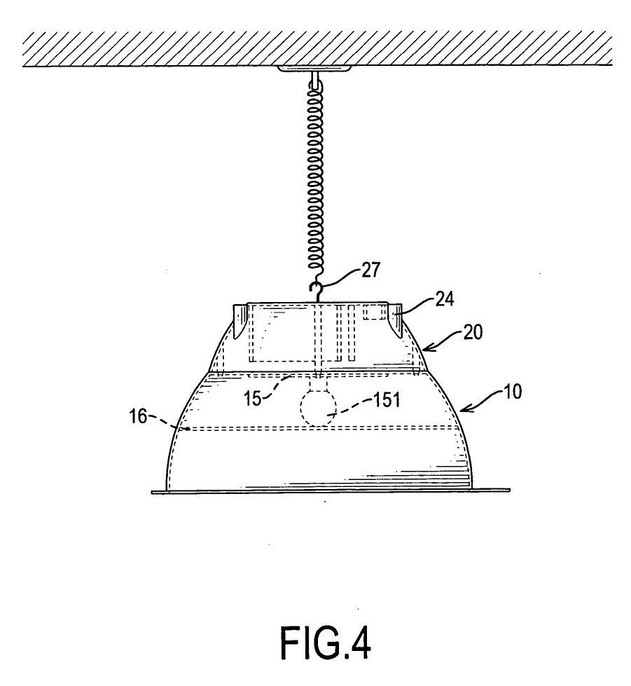

With reference to FIG. 4, the outdoor light in accordance with the present invention can be hung up by the hook (27) to provide area illumination.

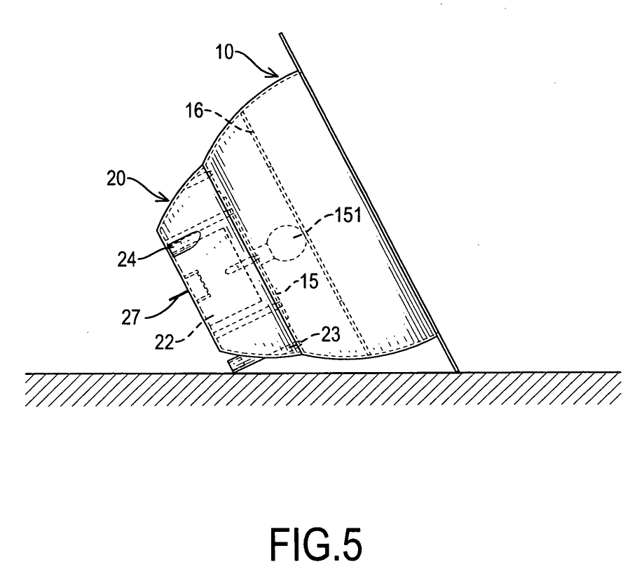

With reference to FIG. 5, the outdoor light is also used on the ground and is supported by the edge of the top (30) and one of the hollow necks (24).

The advantages of the outdoor light in accordance with the present invention are described as follow.

1. The outdoor light provides multiple ways for using, such as putting on the ground, hanging from an object or standing as a table.

2. The top (30) of the outdoor light has pattern defined on the top (30), so people can play games on the outdoor light.

3. The ring (16) of the body (10) adds color to the light and increases the decorative versatility when using the outdoor light.

The invention may be varied in many ways by a person skilled in the art. Such variations are not to be regarded as a departure from the spirit and scope of the invention, and all such modifications are intended to be included within the scope of the following claims.

What is claimed is:

1. An outdoor light, comprising
a body having
a top edge,
a bottom edge,
a bottom,
an internal cavity defined in the body,
a central hole defined in the bottom of the body, and
an illumination source mounted inside the internal cavity,
a base mounted on the bottom of the body and having
a top edge mounted on the bottom of the body,
a bottom,
a cavity defined in the base,
an inner surface,
an outer surface, and
a power supply mounted inside the cavity and connected to the illumination source of the body, and
a top mounted on the top of the body.

2. The outdoor light as claimed in claim 1, wherein the body further comprises a flange formed at the top edge of the body and extending out from the body, and
the top further comprises a bottom surface and a bottom recess defined in the bottom surface of the top,
wherein the flange of the body is mounted inside the bottom recess of the top.

3. The outdoor light as claimed in claim 2, wherein the body further comprises a lip formed at the bottom edge of the body and extending radially into the body, and
the base further comprises multiple post holders formed on the inner surface of the base,
wherein multiple screws screw through the lip of the body and respectively into the post holders of the base.

4. The outdoor light as claimed in claim 3, wherein the body further comprises a ring engaging inside the cavity of the body and having a central hole through which light passes.

5. The outdoor light as claimed in claim 4, wherein the ring of the body is made of a translucent material with colors.

6. The outdoor light as claimed in claim 5, wherein the base further comprises
multiple hollow necks mounted on the outer surface of the base, and
multiple legs connected respectively to the hollow necks, each leg having
a proximal end connected to a corresponding hollow neck.

7. The outdoor light as claimed in claim 6, wherein the base further comprises multiple extension rods mounted between the necks and the legs to connect the necks with the legs, and each extension rod having
a proximal end mounted in a corresponding hollow neck, and
a distal end for a corresponding proximal end of the leg inserting into.

8. The outdoor light as claimed in claim 7, wherein the base further comprises a hook mounted on the outer surface of the base at the bottom.

9. The outdoor light as claimed in claim 8, wherein the top of the outdoor light further comprises a top surface and a pattern defined in the top surface.

10. The outdoor light as claimed in claim 1, wherein the base further comprises
multiple hollow necks mounted on the outer surface of the base, and
multiple legs connected respectively to the necks, each leg having
a proximal end connected to a corresponding hollow neck.

11. The outdoor light as claimed in claim 10, wherein the base further comprises multiple extension rods mounted between the hollow necks and the legs to connect the necks with the legs, and each extension rod having
a proximal end mounted in a corresponding hollow neck, and
a distal end for a corresponding proximal end of the leg inserting into.

12. The outdoor light as claimed in claim 1, wherein the illumination source of the body further comprises a bracket on which the illumination source is mounted and the bracket is mounted on the lip of the body.
